(19) United States
(12) Patent Application Publication
(10) Pub. No.: US 2026/0318465 A1
(43) Pub. Date: Oct. 15, 2026

(54) FIELD REPAIRABLE FLANGELESS LINED PIPING CONNECTION

(71) Applicant: Crane ChemPharma & Energy Corp, The Woodlands, TX (US)

(72) Inventor: Daniel LAPP, Morganton, NC (US)

(21) Appl. No.: 19/483,194

(22) PCT Filed: May 9, 2024
(86) PCT No.: PCT/US2024/028678

§ 371 Date: Nov. 10, 2025

Related U.S. Application Data
(60) Provisional application No. 63/501,309, filed on May 10, 2023.

(51) Int. Cl. F16L 21/08; F16L 15/08; F16L 21/00; F16L 25/00; F16L 47/02

(52) U.S. Cl. CPC F16L 21/08; F16L 15/08; F16L 21/007; F16L 25/009; F16L 47/02

(57) ABSTRACT

A field repairable flangeless lined piping connection system includes a clamshell core (110) operable to fit over an end of each of two piping sections (102, 104) and join the two piping sections. The field repairable flangeless lined piping connection system also includes a coupler assembly (200). The coupler assembly includes a center coupler body (204) having a receiving bore and operable to be disposed over the clamshell core. The coupler assembly also includes a first end coupler (202) and a second end coupler (206) each disposed over one of the two piping sections, wherein each of the first end coupler and the second end coupler include an exterior mirroring the receiving bore of the center coupler body, and wherein the first end coupler and the second end coupler are operable to be inserted into respective ends of the center coupler body.

### TECHNICAL FIELD

The present disclosure relates generally to plastic lined metallic piping for carrying media, and in particular to a field repairable flangeless lined piping connection.

### BACKGROUND

There are particular problems with existing flangeless piping connections in the field of plastic lined metallic pipe, particularly with respect to the lack of ability to disassemble or repair existing flangeless piping connections after they have been installed and sealed.

### SUMMARY

This disclosure relates to a field repairable flangeless lined piping connection for plastic lined metallic pipe.

In one embodiment, a field repairable flangeless lined piping connection system includes a clamshell core operable to fit over an end of each of two piping sections and join the two piping sections which have had their inner plastic liners butt-fusion welded together. The field repairable flangeless lined piping connection system also includes a coupler assembly. The coupler assembly includes a center coupler body having a threaded bore and disposed over the clamshell core. The coupler assembly also includes a first end coupler and a second end coupler each disposed over one of the two lined piping sections, wherein each of the first end coupler and the second end coupler include a threaded exterior operable to be received and threaded into respective ends of the center coupler body.

In another embodiment, a method of installing a field repairable flangeless lined piping connection system includes fitting a clamshell core over an end of each of two piping sections which have had their inner plastic liners butt-fusion welded to one another to join the two lined piping sections. The method also includes threading a first end coupler disposed over one of the two piping sections and a second end coupler disposed over the other of the two lined piping sections into respective ends of a center coupler body, wherein the center coupler body includes a threaded bore, and wherein the center coupler body is disposed over the clamshell core.

In another embodiment, a field repairable flangeless lined piping connection system includes a clamshell core operable to fit over an end of each of two piping sections and join the two lined piping sections. The field repairable flangeless lined piping connection system also includes a coupler assembly. The coupler assembly includes a center coupler body having a receiving bore and operable to be disposed over the clamshell core. The coupler assembly also includes a first end coupler and a second end coupler each disposed over one of the two piping sections, wherein each of the first end coupler and the second end coupler include an exterior mirroring the receiving bore of the center coupler body, and wherein the first end coupler and the second end coupler are operable to be inserted into respective ends of the center coupler body.

In another embodiment, a method of installing a field repairable flangeless lined piping connection system includes arranging two piping sections together, each of the two piping sections having a plastic liner. The method also includes fusing the plastic liner of each of the two piping sections together. The method also includes fitting a clamshell core over an end of each of two piping sections to join the two piping sections. The method also includes disposing a center coupler body having a receiving bore over the clamshell core. The method also includes disposing a first end coupler over one of the two piping sections and a second end coupler over the other of the two piping sections, wherein each of the first end coupler and the second end coupler include an exterior mirroring the receiving bore of the center coupler body. The method also includes inserting the first end coupler and the second end coupler into respective ends of the center coupler body.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication or interaction between two or more elements, whether or not those elements are in physical contact with one another. The term “lined pipe” and its derivatives refer to any metallic pipe, piping, or fittings that have their inner bores lined with a plastic material. The term “coupling” or “coupler” and its derivatives refer to a system or assembly known as a mechanically attached fitting and should be understood to refer to structures known to those skilled in the relevant art. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

As used here, terms and phrases such as “have,” “may have,” “include,” or “may include” a feature (like a number, function, operation, or component such as a part) indicate the existence of the feature and do not exclude the existence of other features. Also, the phrase “at least one of,” when used with a list of items, means that different combinations of one or more of the listed items may be used, and only one item in the list may be needed. For example, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first component and a second component may indicate different components from each other, regardless of the order or importance of the components. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be mechanically attached, coupled, or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

It should be understood that the term “plurality,” as used herein, means two or more. The terms “outboard” and “inboard” refer to the relative position of different features relative to a common axis or plane. The term “coupled” means connected to or engaged with, whether directly or indirectly, for example with an intervening member, and does not require the engagement to be fixed or permanent, although it may be fixed or permanent (or integral). The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. For example, a “first” diameter may be later referred to as a “second” diameter depending on the order in which they are referred. It should also be understood that designation of “first” and “second” does not necessarily mean that the two components or values so designated are different, meaning for example a first diameter may be the same as a second diameter, with each simply being applicable to separate components. The terms “vertical” and “horizontal” refer to the orientation of various components as shown in the drawings, but with the understanding that those components may be rotated and used in other orientations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases are provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description, taken in conjunction with the accompanying drawings, in which:

FIGS. 1A-1F illustrate various views of a field repairable flangeless lined piping connection in accordance with this disclosure;

FIGS. 2A-2E illustrate various views of a coupler assembly in accordance with this disclosure;

FIGS. 3A-3H illustrate various views of a piping and coupler assembly during various stages of an installation process in accordance with this disclosure;

FIGS. 4A-4D illustrate various views of a flangeless lined piping connection with the coupler assembly installed and fully assembled in accordance with this disclosure;

FIGS. 5A-5D illustrate various views of another example of a field repairable flangeless lined piping connection in accordance with this disclosure;

FIGS. 6A-6D illustrate another example of a field repairable flangeless lined piping connection in accordance with this disclosure;

FIGS. 7A-7C illustrate another example of a field repairable flangeless lined piping connection in accordance with this disclosure; and

FIG. 8 illustrates a method of installing a field repairable flangeless lined piping connection system in accordance with this disclosure.

### DETAILED DESCRIPTION

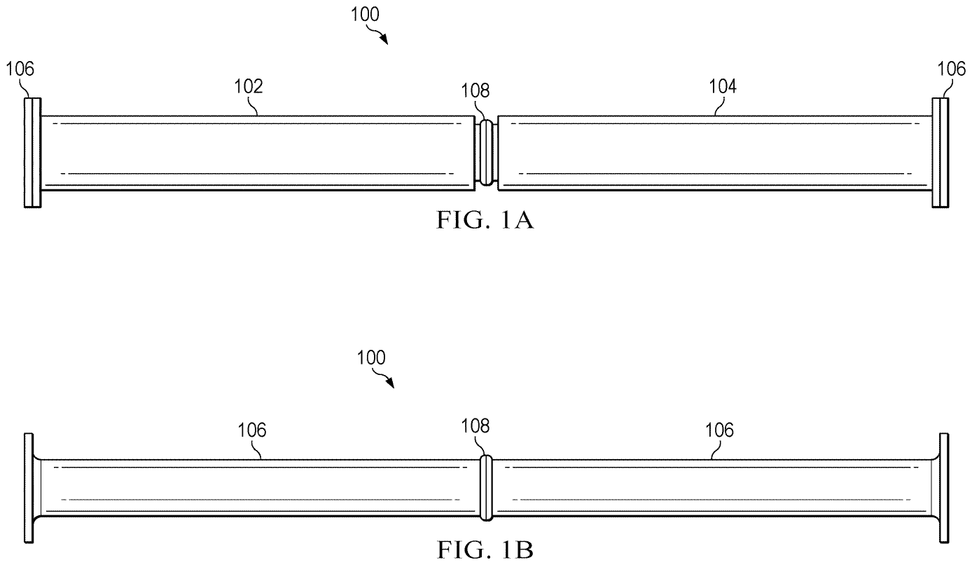

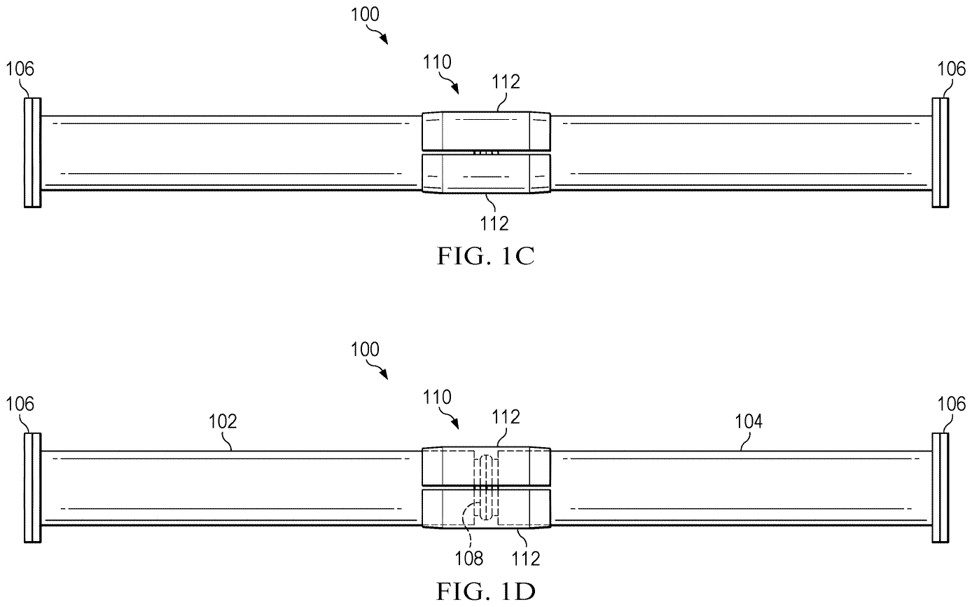

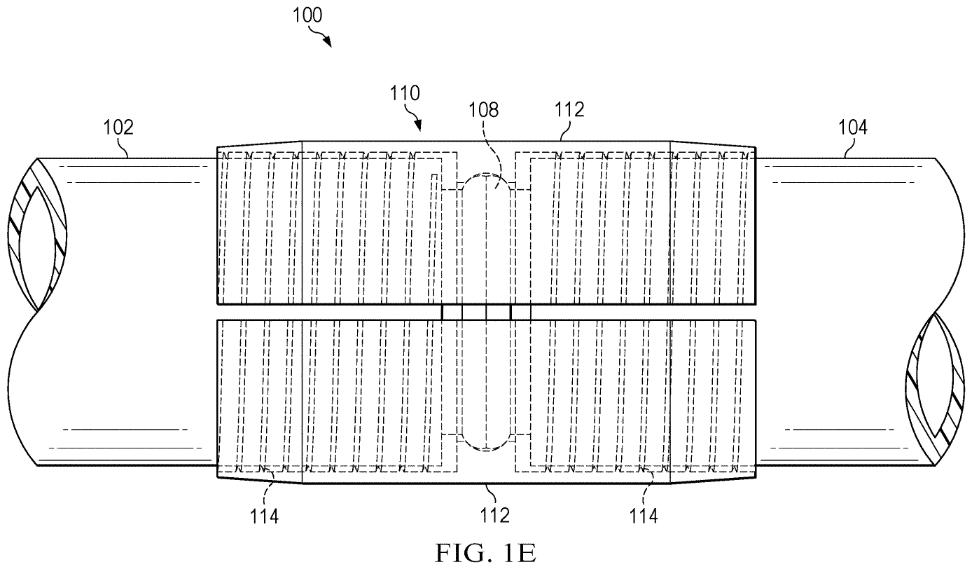

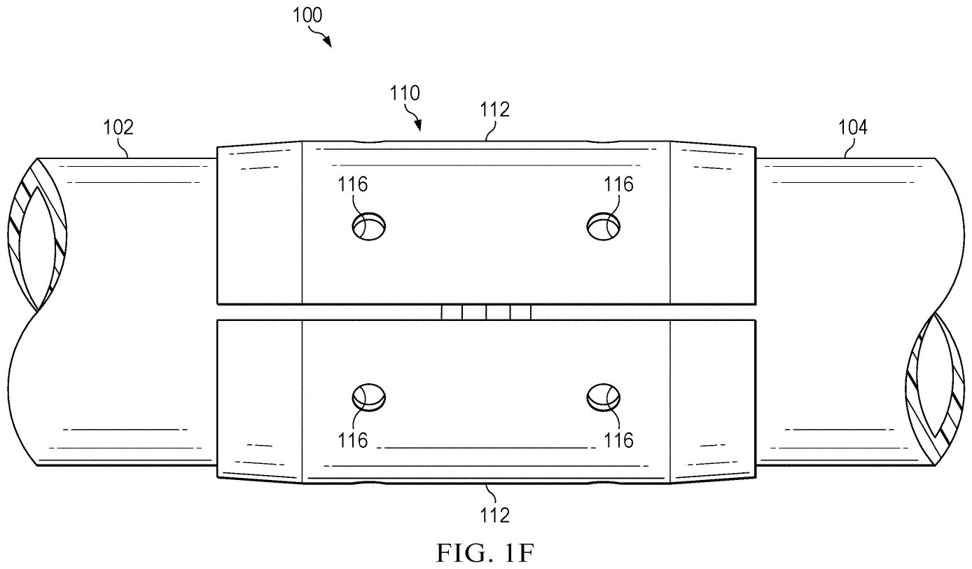

FIGS. 1A through 8, discussed below, and the various embodiments used to describe the principles of the present disclosure in this patent document are by way of illustration only and should not be construed in any way to limit the scope of the disclosure. Those skilled in the art will understand that the principles of this disclosure may be implemented in any suitably arranged device or system.

As noted above, there are particular problems with existing flangeless lined piping connections, particularly with respect to the lack of ability to disassemble or repair existing flangeless lined piping connections after they have been sealed. Such existing flangeless lined piping connections often include a liner, such as a polymeric liner, within an interior of the separate sections of piping to be connected and sealed together. During assembly, heat is applied to melt or fuse the adjacent liner ends together to create the seal, then a large cylinder compression tool or crimping machine is used to swage a coupler onto the two ends of the metallic pipe housing, and one or more swage or drive rings are used to hold the connection.

Existing piping connections may have two sections of piping with liners being joined and swage or drive rings disposed around the two sections of piping. Upon compression of the piping using a compression or crimping machine, the swage or drive ring deforms the sections of piping and holds pressure to permanently join the two sections of piping. The two sections of piping may also have liners that are fused together by welding the liners together prior to the swage or drive rings. Existing flangeless piping connections are also described in U.S. Pat. No. 5,730,472, which is incorporated by reference herein in its entirety.

Existing flangeless joints such as described above eliminate a leak-path and maintenance on the joint, but at the cost of a difficult and expensive initial installation. As stated, this installation requires a crimping machine that is often restrictively heavy and large. Additionally, the coupler joint that replaces the flange is often restrictively expensive with a long lead time. In couplers that include a lined piping, the liners are fused prior to the mechanical coupler and therefore the leak prevention of the exterior coupler is unnecessary and thereby over-engineered for lined pipe applications. Additionally, the existing designs described above make it impossible to disassemble or repair the coupled piping, making updates or upgrades to the piping system a complete replacement effort.

This disclosure provides a coupler that can be assembled with simple tooling, and which also provides similar mechanical rigidity of the existing couplers, but is also designed in a way that accounts for the nature of the fused liner which reduces the complexity of the assembly. Additionally, the coupler of the present disclosure includes a design that can be disassembled and/or repaired at the customer's or end user's discretion a plurality of times.

FIGS. 1A-1F illustrate various views of a field repairable flangeless lined piping connection 100 in accordance with this disclosure. As shown in FIG. 1A, the field repairable flangeless lined piping connection 100 includes two sections of lined piping comprising a first section 102 and a second section 104 each having polymeric liners 106 that have been welded together at a weld 108. As shown in FIG. 1A, the weld 108 can be a butt-fusion weld of the polymeric liners 106 at a center portion where the two liners 106 of the first section 102 and second section 104 of the piping meet. FIG. 1B shows the fused liners 106 without the first section 102 and the second section 104 of the piping visible.

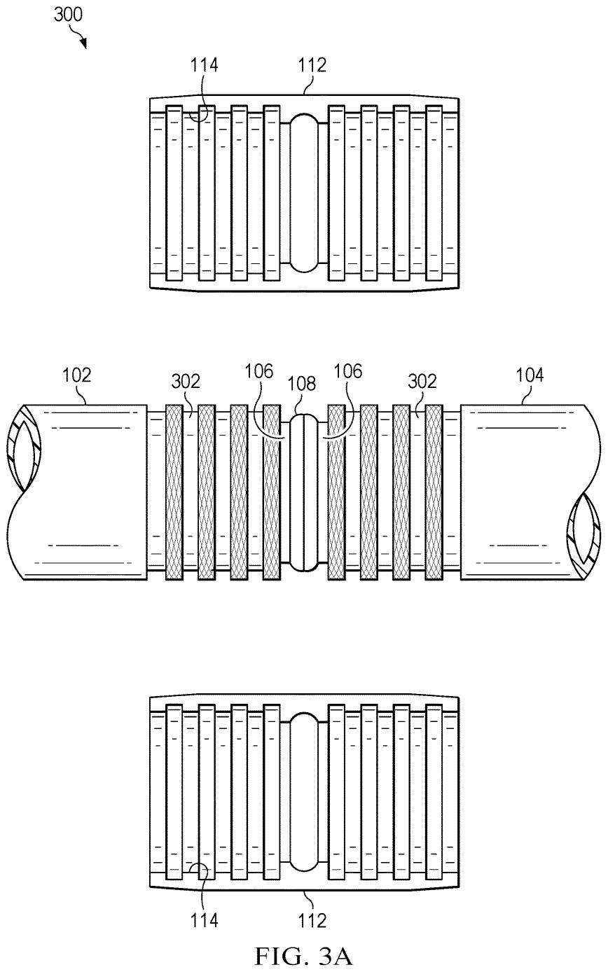

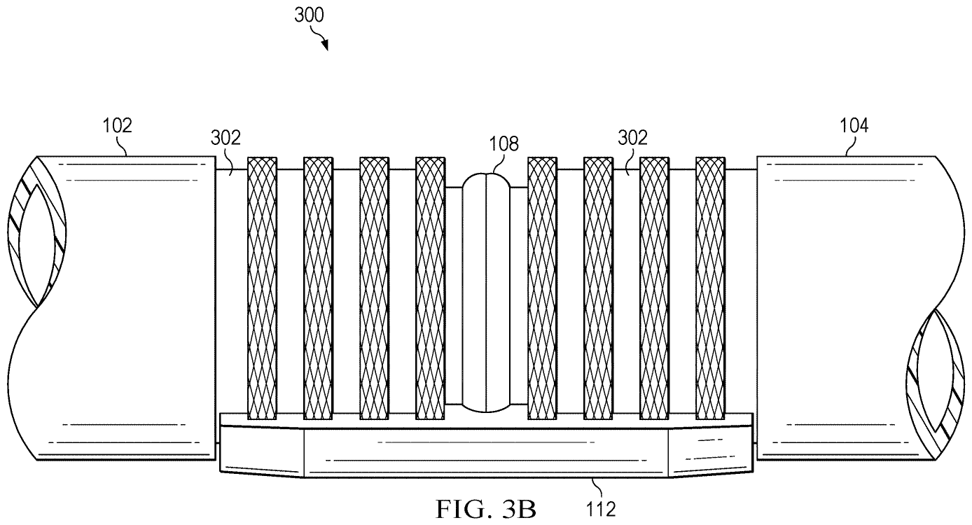

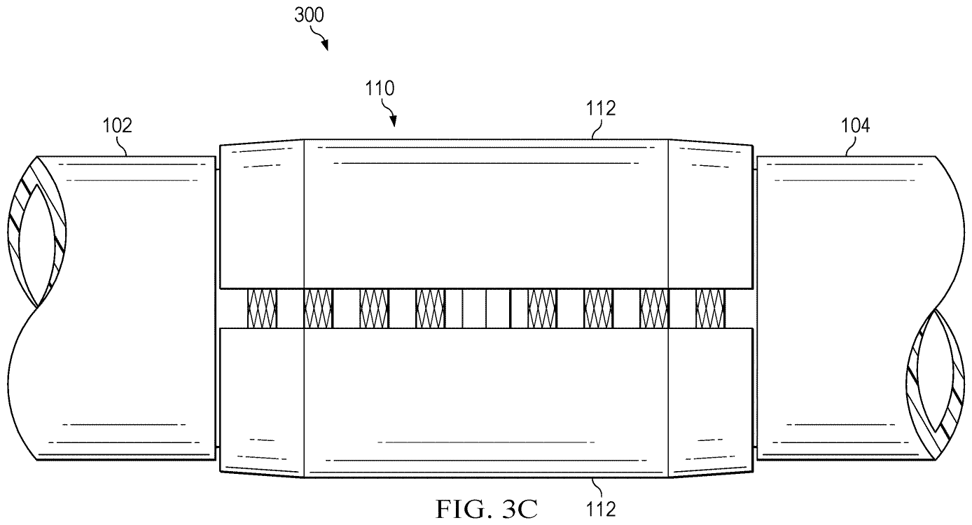

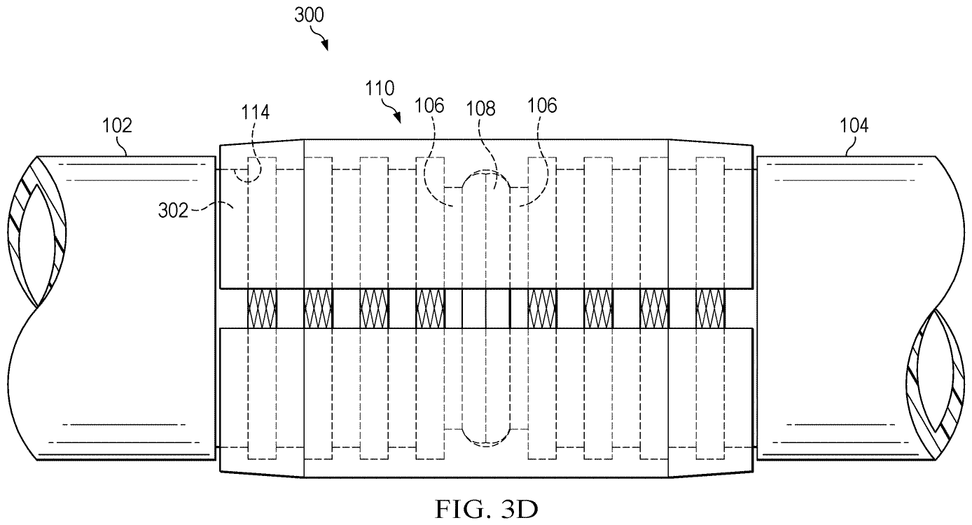

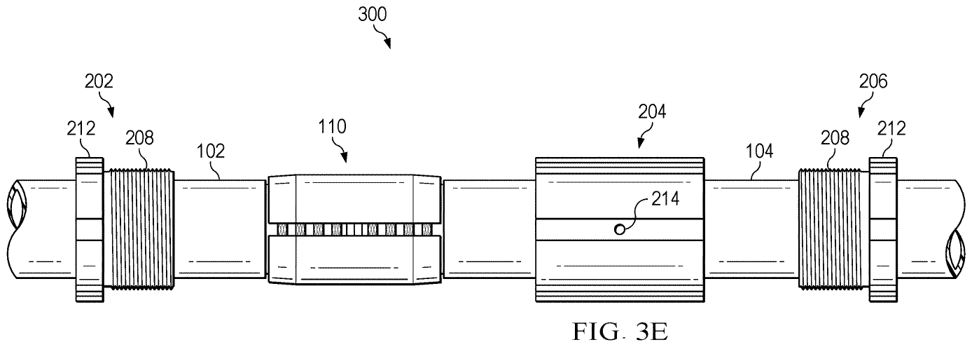

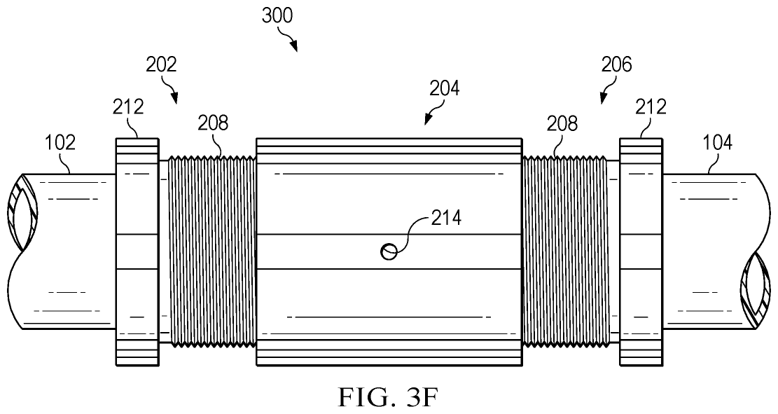

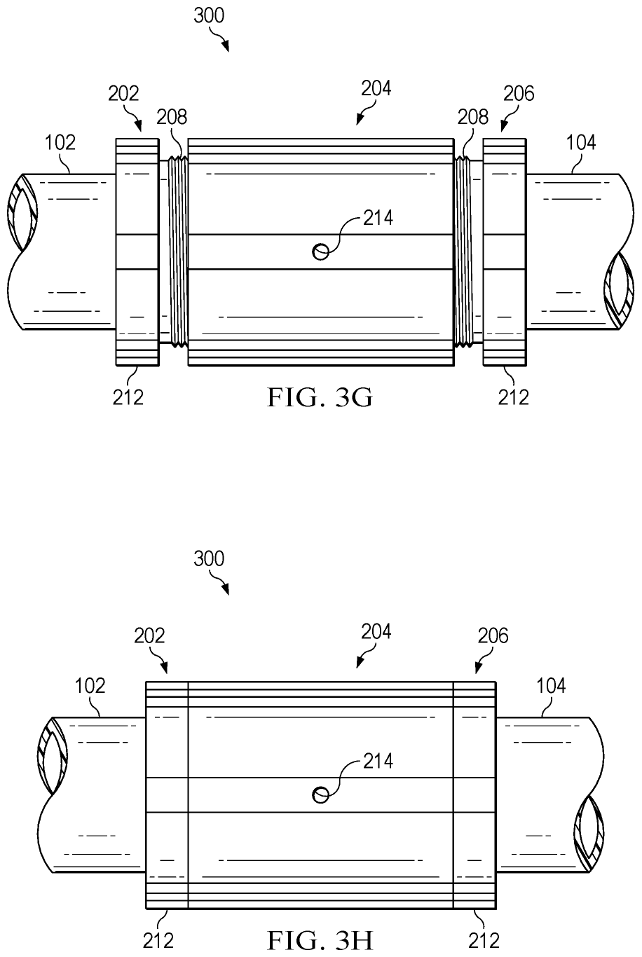

As shown in FIG. 1C, to initially join the two sections of piping 102, 104, a clamshell core 110 is fitted over an end of each of the two sections of piping 102, 104 to act as both an axial and torsional restriction for the joined piping. In various embodiments of this disclosure, the clamshell core 110 includes two pieces 112 that can be knurled. In some embodiments, the two pieces 112 have teeth 114 that can fit into or mesh with machined grooves (see also FIGS. 3A-3H) of the two sections of piping 102, 104. In some embodiments, such as shown in FIG. 1F that illustrates another view of the clamshell core 110 installed on the two sections of piping 102, 104, the two pieces 112 of the clamshell core can have apertures 116 shown that can each receive a fixation device such as a set screw to hold the clamshell core 110 together.

In some embodiments, the clamshell core 110 can have both the teeth 114 and the apertures 116 to secure the clamshell core 110 to the piping using both a meshed interaction between the teeth 114 and the machined grooves and set screws installed through the apertures 116. In some embodiments, the clamshell core 110 can have just the teeth 114 and no apertures 116 to secure the clamshell core 110 to the piping using just a meshed interaction between the teeth 114 and the machined grooves. In some embodiments, the clamshell core 110 can have no teeth 114 and just the apertures 116, such that only the apertures 116 are used to receive set screws to secure the clamshell core 110 to the piping, such as in embodiments where the piping does not have machined grooves.

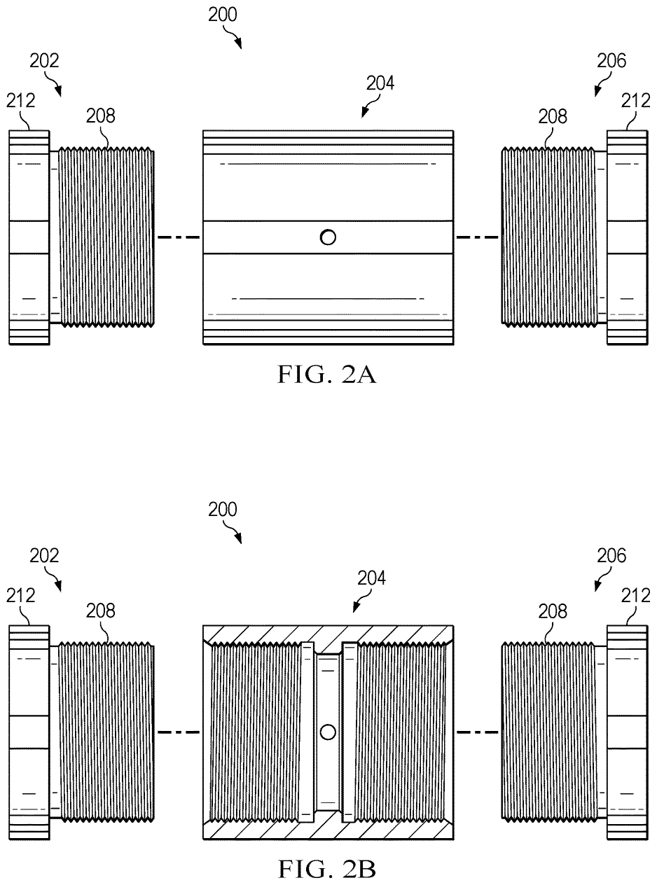

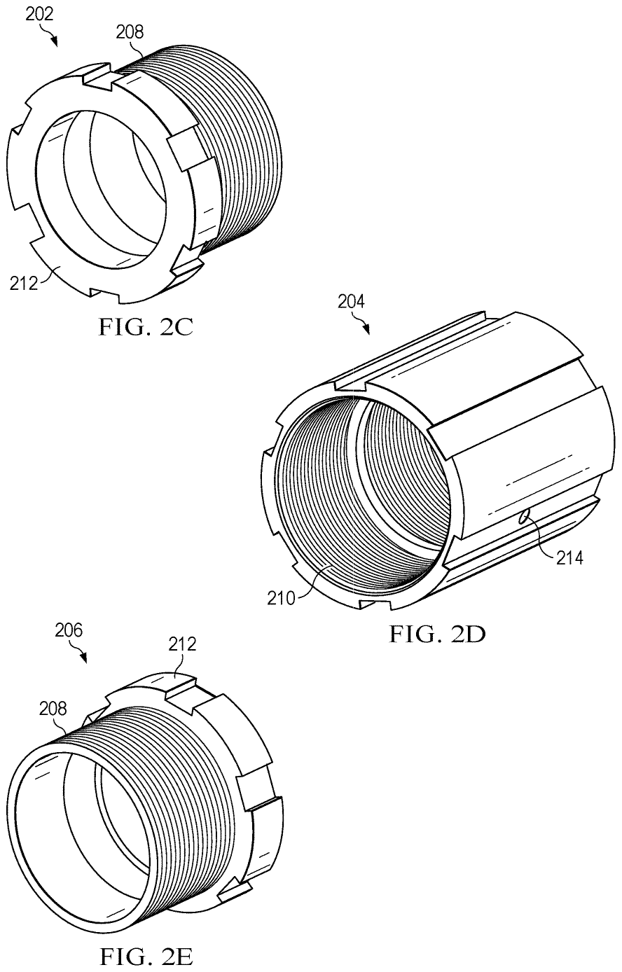

Reference is now made to FIGS. 2A-2E, which illustrate various views of a coupler assembly 200 in accordance with this disclosure, and also to FIGS. 3A-3H, which illustrate various views of a piping and coupler assembly 300 during various stages of an installation process in accordance with this disclosure. As shown in the example views of FIGS. 3A-3D, and as also described with respect to FIGS. 1A-1F, the field repairable lined flangeless piping connection of this disclosure includes a polymeric liner 106 in each of the two sections of piping 102, 104 that is heated to fuse the liners together at a weld or fused portion 108 in a center area where the two sections of piping 102, 104 are joined. The two sections of piping 102, 104 and the liner 106 are then covered by the clamshell core 110 having two pieces 112. In various embodiments of this disclosure, such as shown in FIGS. 3A-3D, the two pieces 112 of the clamshell core 110 includes two pieces 112 that they have teeth 114 that can fit into or mesh with machined grooves 302 of the two sections of piping 102, 104. During a repair or replacement process of the joined piping, the fused liner 106 can be cut in the middle fused portion 108, and the liners 106 can be re-fused at or near completion of the repair or replacement process.

As shown in FIGS. 2A-2E, the coupler assembly 200 includes a first end coupler 202 (also shown separately in FIG. 2C), a center coupler body 204 (also shown separately in FIG. 2D), and a second end coupler 206 (also shown separately in FIG. 2E). The first end coupler 202 and the second end coupler 206 can be threaded nuts that threadedly engage with respective ends of the center coupler body 204. The first and second end couplers 202, 206 are each positioned around the first and second section 102, 104 of piping, respectively, and the center coupler body 204 is disposed between the two end couplers 202, 206, as shown for example in FIG. 3E. As shown in FIGS. 2A and 2B, during installation, the end couplers 202, 206, having threaded portions 208 thereof, are threaded into respective ends of the center coupler body 204 via corresponding threaded sections 210 of the center coupler body 204, such as by initially rotating head portions 212 of the end couplers 202, 206. In some embodiments, the end couplers 202, 206 could be tack welded to the coupler body 204.

As shown in FIGS. 3E-3H, the center coupler body 206 is fitted over the clamshell core 110. Then, the first and second end couplers 202, 206 are threaded into the center coupler body 206 until tight, such as by using a spanner wrench in an aperture 214 of the center coupler body 206. Unlike prior flangeless lined piping connections that are permanently fixed by a swage or drive ring, the flangeless lined piping connection of the embodiments of this disclosure allow for the coupler assembly 200 to be dissembled, such as by using a spanner wrench, such as if one of the two sections of piping 102, 104 needs to be replaced with a new section of piping that is then re-welded to the remaining section in the same way as described above, providing a distinct utility advantage over prior flangeless lined piping connections.

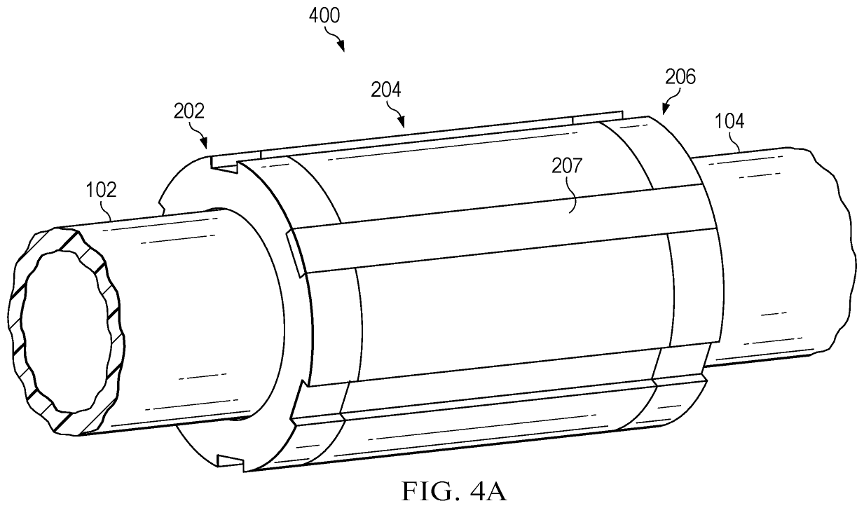

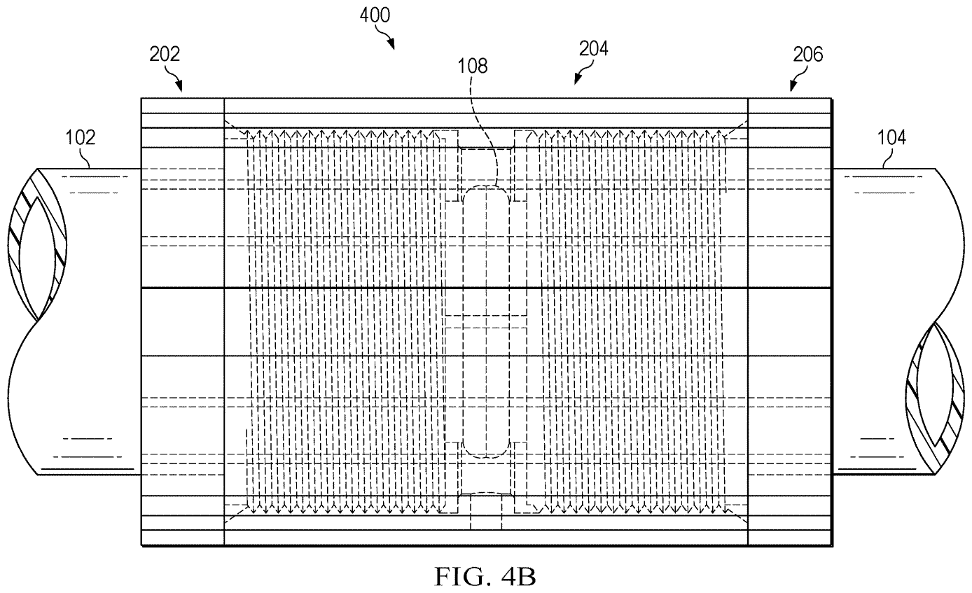

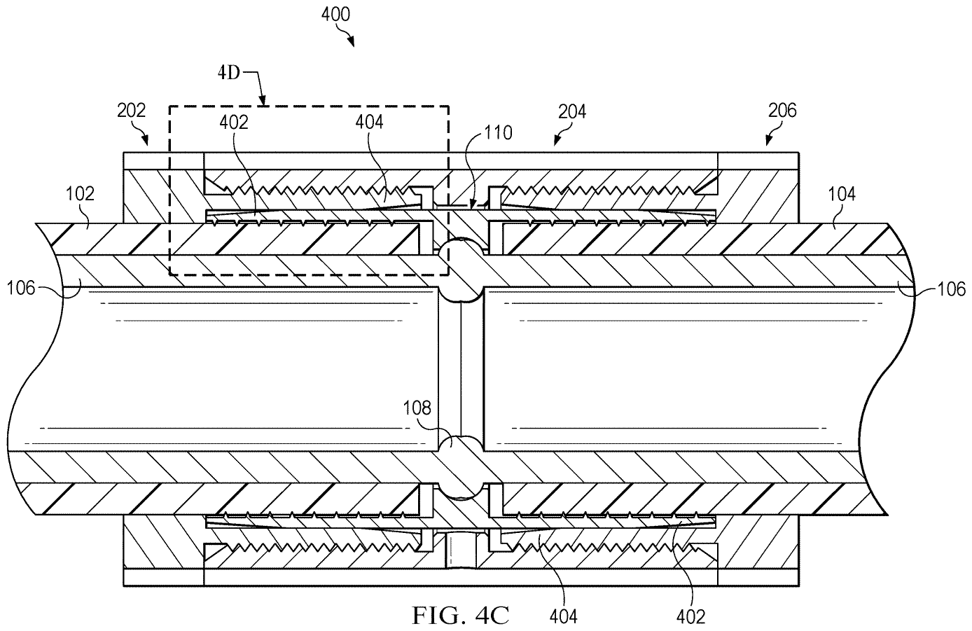

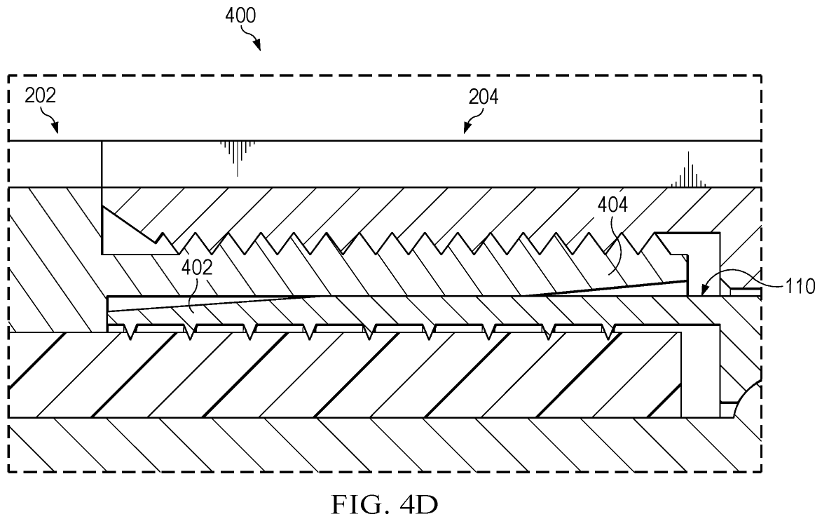

FIGS. 4A-4D illustrate various views of a flangeless lined piping connection 400 with the coupler assembly 200 installed and fully assembled in accordance with this disclosure. As shown in FIGS. 4A and 4B, the coupler assembly 200 fully encloses the joined sections of piping 102 and 104.

As also shown in FIGS. 4A and 4B, the field repairable flangeless lined piping connection 400 includes the fully threaded and set coupler assembly 200 as described above that is mechanically rigid and sealed from leakage. As also described herein, during the assembly process, internal liners 106 can be fused together to provide a seal that prevents leakage.

As described with respect to FIGS. 2A-2E and 3A-3H, and as also shown in FIGS. 4B-4D, the center coupler body 204 of the coupler assembly 200 includes threaded apertures operable to receive threaded nuts, i.e., the first and second end couplers 202, 206 disposed between the clamshell core 110 and the coupler body 204, to further join the clamshell 110 and the coupler assembly 200 to provide support for the full coupled assembly. In some embodiments, the clamshell core 110 includes tapered portions 402 with a slight taper and the end couplers 202, 206 each include tapered portions 404. The tapered portions 402, 404 cause the nuts 202, 206 to force a mechanical deformation of the two sections of piping 102, 104 via an interference fit between the nuts 202, 206 and the clamshell core 110, further locking the assembly into place. Additionally, as shown in FIG. 4A, a retaining bar 207 can also be included in the coupler assembly 200 that assists with preventing the first and second end couplers 202, 206 from backing off or otherwise moving away from the center coupler body 204.

Although FIGS. 1A-4D illustrate various example views of a field repairable flangeless lined piping connection, various changes may be made to FIGS. 1A-4D. For example, in addition to the alternative embodiments described above, the piping can be of various other dimensions or shapes than that shown in FIGS. 1A-4D. In general, piping comes in a wide variety of configurations, and FIGS. 1A-4D do not limit the scope of this disclosure to any particular configuration.

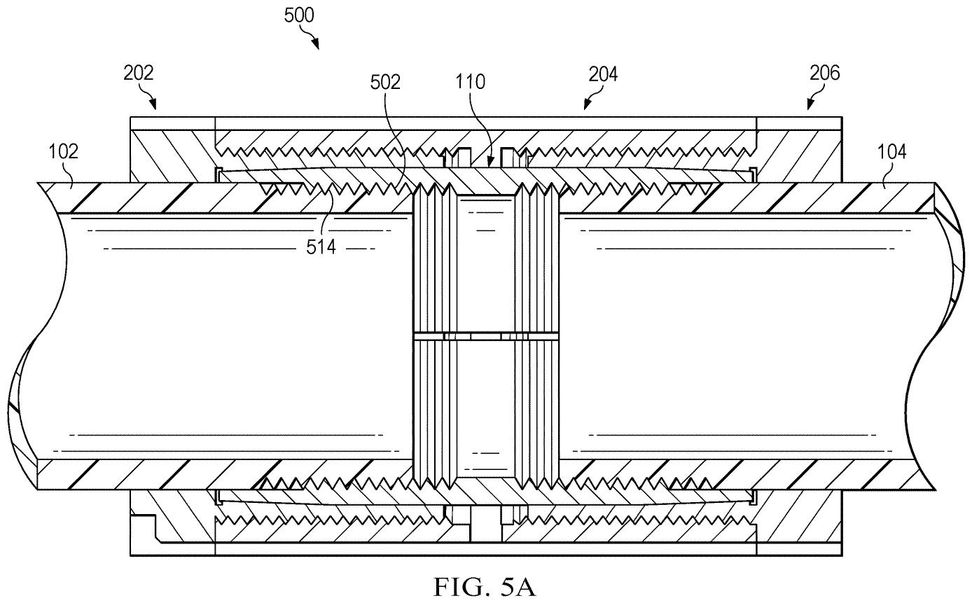

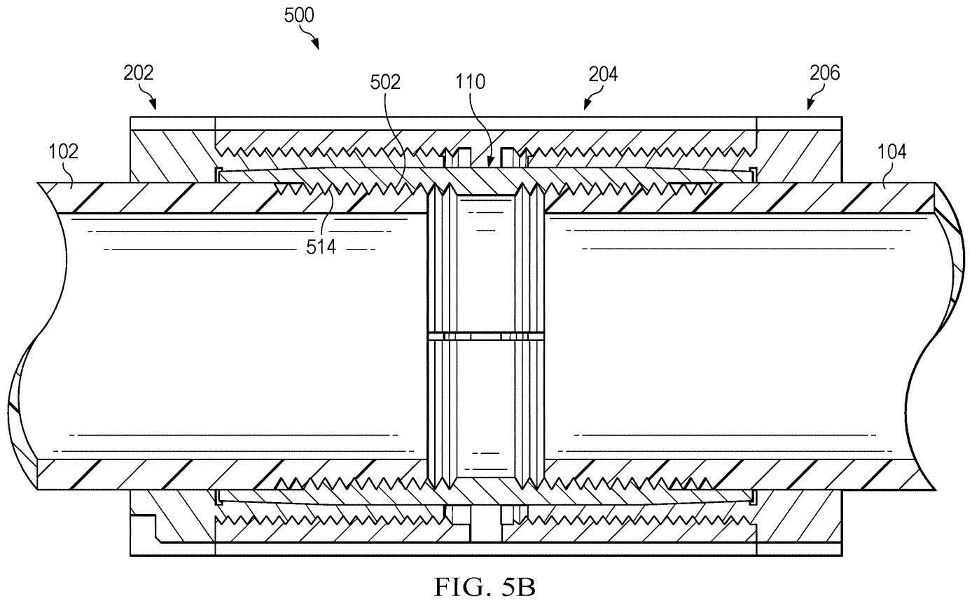

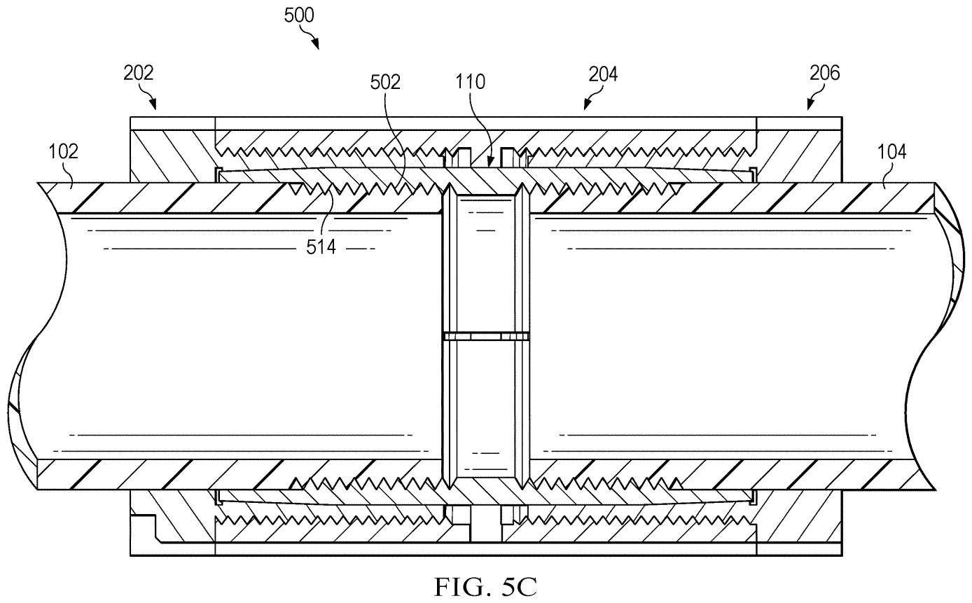

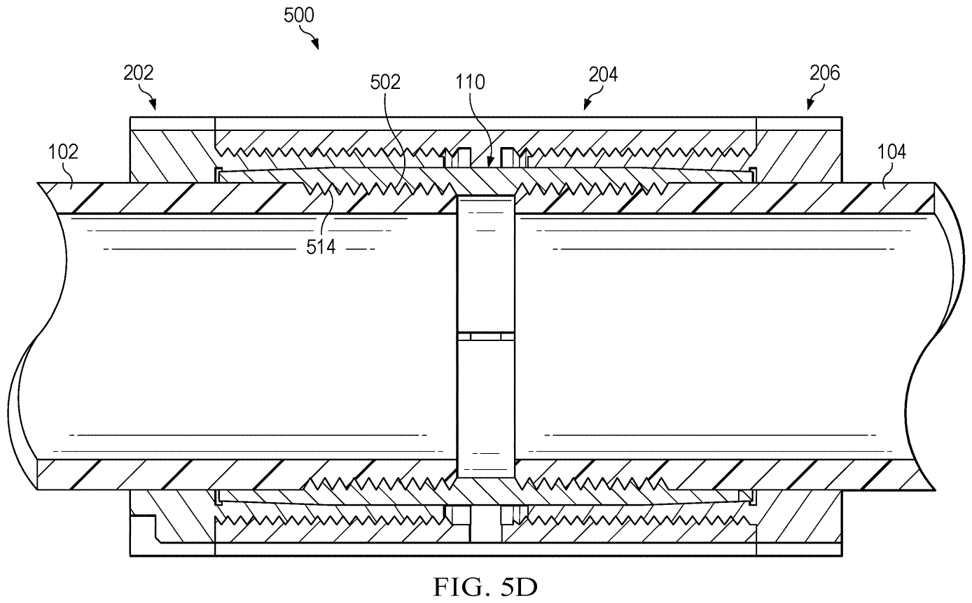

FIGS. 5A-5D illustrate various views of another example of a field repairable flangeless lined piping connection 500 in accordance with this disclosure. To allow for repairs to be performed without being restricted by a set distance imposed by machine grooves of the piping sections, a grooved-indexable design can be used. For example, as shown in FIGS. 5A-5D, the field repairable flangeless lined piping connection 500 includes teeth 502 of the first and second sections 102, 104 of piping and teeth 514 of the clamshell core 110 that are created by radially machined grooves, rather than being threads.

This grooved-indexable design includes multiple spacing settings that can accept and set multiple widths. In the example shown in FIGS. 5A-5D, this allows for multiple repair welds, with FIG. 5A showing a first weld and with three subsequent repair welds shown in FIGS. 5B, 5C, and 5D, respectively. As shown in FIG. 5A, the first weld has a largest width available for the weld, with three teeth 514 of the clamshell core 110 being disposed in a center area between the two sections of piping 102, 104 where the weld is made. In FIG. 5B, a next weld is performed after a repair is made of the field repairable flangeless lined piping connection 500, such that the width of the weld area is smaller, such that there are now two teeth 514 of the clamshell core 110 disposed in the center area between the two sections of piping 102, 104 where the weld is made, and such that the two sections of piping 102, 104 are both notched in one step of the teeth 514.

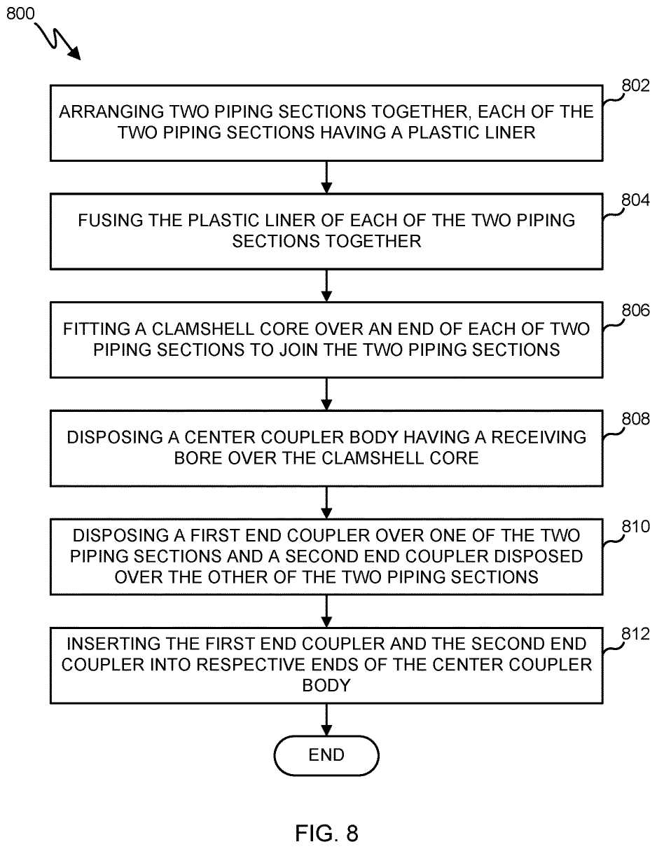

In FIG. 5C, yet a next weld is performed after a repair is made of the field repairable flangeless lined piping connection 500, such that the width of the weld is smaller still as compared to FIG. 5B, such that there is now one tooth 514 of the clamshell core 110 disposed in the center area between the two sections of piping 102, 104 where the weld is made, and such that the two sections of piping 102, 104 are both notched in another step of the teeth 514. FIG. 8D shows a smallest width for a weld, such that there are now no teeth 514 of the clamshell core 110 disposed in the center area between the two sections of piping 102, 104 where the weld is made, and such that the two sections of piping 102, 104 are both notched in yet another step of the teeth 514. Each repair weld can thus be indexed a degree each time, such as 0.0625 inches each time, which can correspond to the amount of material one would remove to clean up the cut and create a new weld of the polymeric liner.

Although FIGS. 5A-5D illustrate one example of a field repairable flangeless lined piping connection 500, various changes may be made to FIGS. 5A-5D. For example, although an indexed degree of 0.0625 inches is mentioned above, other indexed degrees are within the scope of this disclosure. Also, in various embodiments, the shape of the teeth 502 and the teeth 514 may differ. For example, in FIGS. 5A-5D, the teeth 502 and the teeth 514 are shaped to have sharper edges, but other shapes can be used without departing from the scope of this disclosure, such as the curved ridge shape of the teeth 114 shown for example in FIGS. 3A-3H. Additionally, in addition to the alternative embodiments described above, the piping can be of various other dimensions or shapes than that shown in FIGS. 5A-5D. In general, piping comes in a wide variety of configurations, and FIGS. 5A-5D do not limit the scope of this disclosure to any particular configuration.

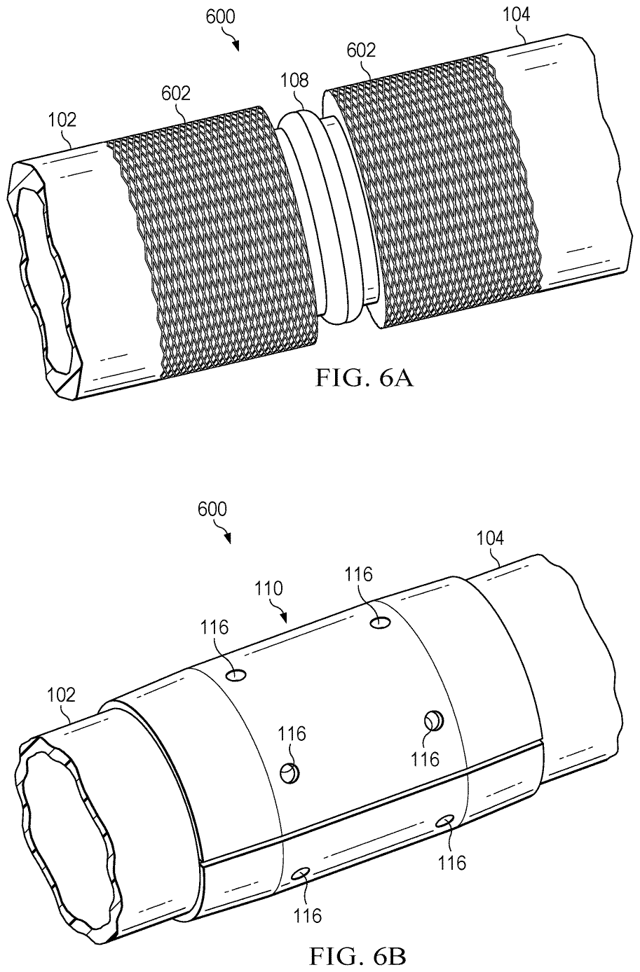

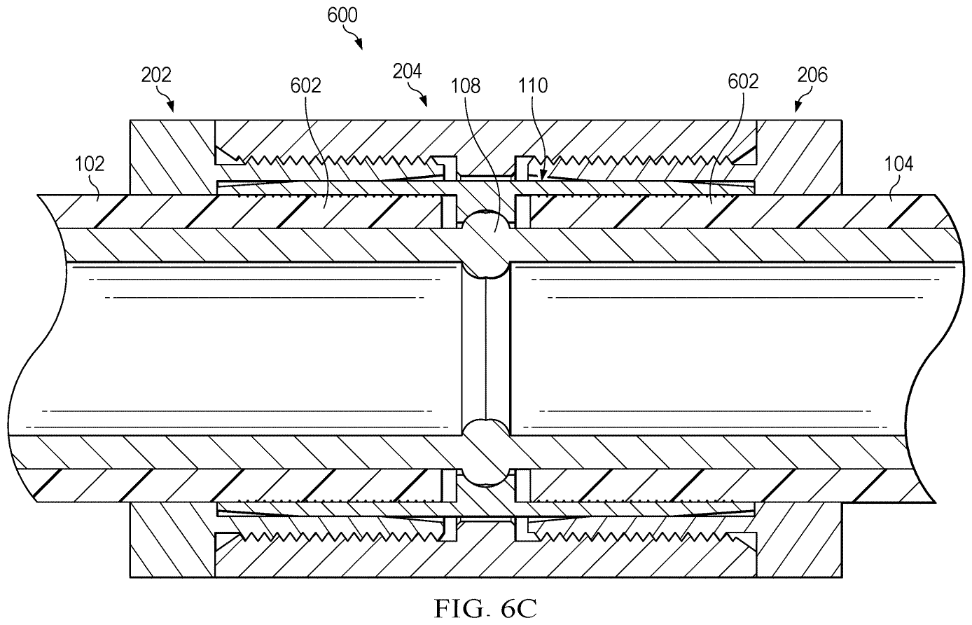

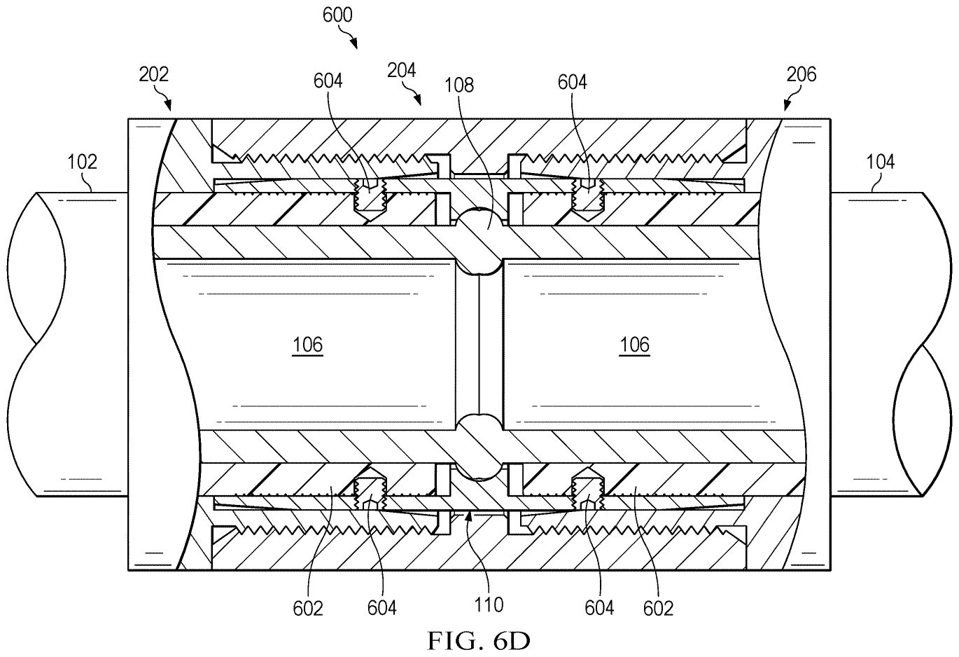

FIGS. 6A-6D illustrate another example of a field repairable flangeless lined piping connection 600 in accordance with this disclosure. As shown in FIG. 6A, the first section 102 and the second section 104 of piping of the field repairable flangeless lined piping connection 600 each includes knurled ends 602 (rather than machined grooves). This avoids restrictions on the pipe-to-pipe spacing. As shown in FIG. 6B, the clamshell core 110 includes a plurality of apertures 116 for receiving set screws. The set screws can replace some of the interference to limit the connection's susceptibility to torsion. This can be especially useful when dealing with larger piping and associated connections. Use of set screws in various embodiments can further enhance the strength of the coupler. In some embodiments, the internal diameter of the clamshell core 110 that will be disposed around the outer diameter of the metallic pipe also includes a knurled design to enhance the connection's resistance to external forces such as bending moment, torsion, and axial stress.

FIG. 6C shows a cross-sectional view of the fully assembled field repairable flangeless lined piping connection 600. The knurling on the outside of the two sections of piping 102, 104 (and/or on the inside of the clamshell core 110, in some embodiments) provides resistance between the piping and the clamshell core 110 and allows, within reason, for no set restrictions on where the pipe resides within the assembly, and thus allows for any pipe spacing for the original spacing or subsequent repair welds.

FIG. 6D shows another cross-sectional view of the fully assembled field repairable flangeless lined piping connection 600, showing the first and second piping sections 102, 104 making up an outer steel pipe shell, the plastic liners 106, the butt-weld 108, the clamshell 110 (i.e., a compression ring), the first and second end couplers 202, 206 (i.e., swage nuts), the coupler body 204, and set screws 604 installed in the clamshell 110.

Although FIGS. 6A-6D illustrate one example of a field repairable flangeless lined piping connection 600, various changes may be made to FIGS. 6A-6D. For example, in addition to the alternative embodiments described above, the piping can be of various other dimensions or shapes than that shown in FIGS. 6A-6D. In general, piping comes in a wide variety of configurations, and FIGS. 6A-6D do not limit the scope of this disclosure to any particular configuration.

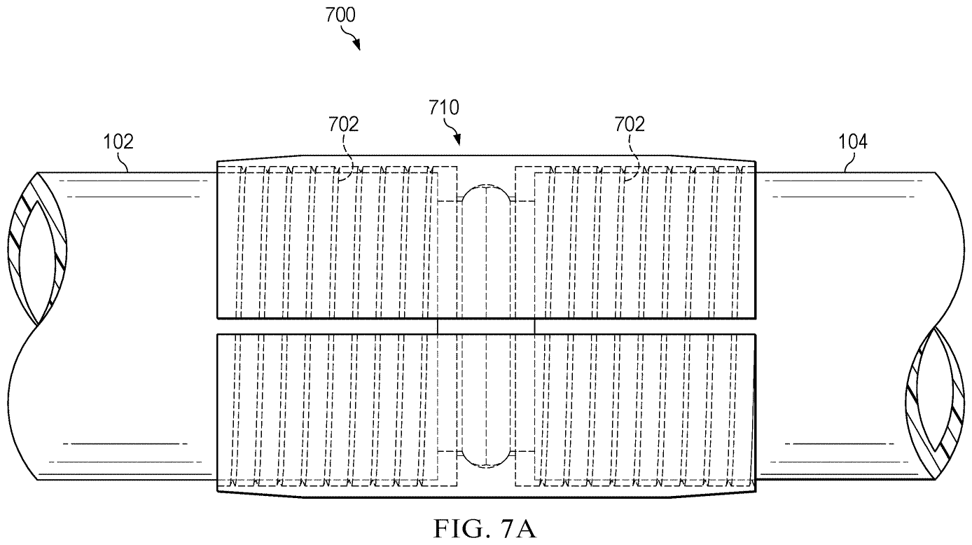

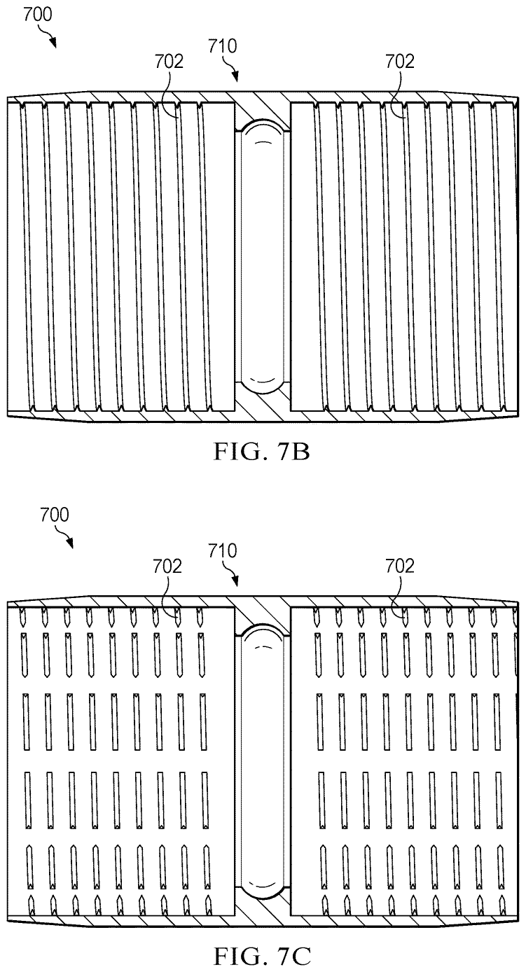

FIGS. 7A-7C illustrate another example of a field repairable flangeless lined piping connection 700 in accordance with this disclosure. As shown in FIG. 7A, the field repairable flangeless lined piping connection 700 of FIGS. 7A-7C includes a design in which the clamshell core 710 has ridges or teeth 702 machined into the body of the clamshell core 710 (rather than machined grooves). This avoids restrictions on the pipe-to-pipe spacing. As shown in FIGS. 7B and 7C, the clamshell core includes a plurality of ridges 702 for the purpose of digging into the metallic structure of the pipe. The use of more ridges 702 in this and other embodiments such as in FIG. 7C can further enhance the strength of the coupler to enhance the connections resistance to external forces such as bending moment, torsion, and axial stress. As illustrated in FIG. 7A, there is no need for alteration to the outside of the metallic pipe housing in this embodiment which allows, within reason, for no set restrictions on where the pipe resides within the assembly, and thus allows for any pipe spacing for the original spacing or subsequent repair welds.

Although FIGS. 7A-7C illustrate one example of a field repairable flangeless lined piping connection 700, various changes may be made to FIGS. 7A-7C. For example, the ridges 702 can be of varying number and placements than that shown in FIGS. 7A-7C. Also, in addition to the alternative embodiments described above, the piping can be of various other dimensions or shapes than that shown in FIGS. 7A-7C. In general, piping comes in a wide variety of configurations, and FIGS. 7A-7C do not limit the scope of this disclosure to any particular configuration.

FIG. 8 illustrates a method 800 of installing a field repairable flangeless lined piping connection system in accordance with this disclosure. It will be understood that the method 800 can be used with the various embodiments of the field repairable flangeless lined piping connections of this disclosure.

At step 802, two piping sections are arranged together, each of the two piping sections having a plastic liner. At step 804, the plastic liner of each of the two piping sections are fused together. At step 806, a clamshell core is fitted over an end of each of two piping sections to join the two piping sections. At step 808, a center coupler body is disposed having a receiving bore over the clamshell core. At step 810, a first end coupler is disposed over one of the two piping sections and a second end coupler is disposed over the other of the two piping sections. As described in this disclosure, each of the first end coupler and the second end coupler can include an exterior mirroring the receiving bore of the center coupler body. At step 812, the first end coupler and the second end coupler are inserted into respective ends of the center coupler body.

Although FIG. 8 illustrates one example of a method 800 of installing a field repairable flangeless lined piping connection system, various changes may be made to FIG. 8. For example, while shown as a series of steps, various steps in FIG. 8 could overlap, occur in parallel, occur in a different order, or occur any number of times (including zero times).

In one example embodiment, a field repairable flangeless lined piping connection system comprises a clamshell core operable to fit over an end of each of two piping sections and join the two lined piping sections and a coupler assembly. The coupler assembly includes a center coupler body having a receiving bore and operable to be disposed over the clamshell core, and a first end coupler and a second end coupler each disposed over one of the two piping sections, wherein each of the first end coupler and the second end coupler include an exterior mirroring the receiving bore of the center coupler body, and wherein the first end coupler and the second end coupler are operable to be inserted into respective ends of the center coupler body.

In one or more of the above examples, insertion of the first and second end couplers into the center coupling body imparts a force to create a mechanical deformation via an interference fit.

In one or more of the above examples, the clamshell core and the first and second end couplers each include tapered sections used to impart the force to create the mechanical deformation via the interference fit.

In one or more of the above examples, one or more set screws are disposed in one or more respective apertures of the clamshell core to provide structural rigidity.

In one or more of the above examples, the end of each of the two piping sections includes knurled sections that provide a mechanical resistance with the clamshell core.

In one or more of the above examples, a body of the clamshell core includes ridges that provide a mechanical resistance with the two piping sections.

In one or more of the above examples, the clamshell core includes teeth that mesh with grooves on an outside portion of the two piping sections.

In one or more of the above examples, the clamshell core includes two separate pieces that are operable to fit over the end of each of the two piping sections.

In one or more of the above examples, the two piping sections include indexed teeth that mesh with teeth of the clamshell core, and wherein a set of the indexed teeth of the two piping sections is operable to be removed during a repair procedure.

In one or more of the above examples, the first and second end couplers each include a threaded portion that interfaces with an interior threaded portion of the center coupler body during insertion of the first and second end couplers into the respective ends of the center coupler body.

In another example embodiment, a method of installing a field repairable flangeless lined piping connection system comprises arranging two piping sections together, each of the two piping sections having a plastic liner, fusing the plastic liner of each of the two piping sections together, fitting a clamshell core over an end of each of two piping sections to join the two piping sections, disposing a center coupler body having a receiving bore over the clamshell core, disposing a first end coupler over one of the two piping sections and a second end coupler over the other of the two piping sections, wherein each of the first end coupler and the second end coupler include an exterior mirroring the receiving bore of the center coupler body, and inserting the first end coupler and the second end coupler into respective ends of the center coupler body.

In one or more of the above examples, inserting the first and second end couplers into the center coupler body imparts a force to create a mechanical deformation via an interference fit.

In one or more of the above examples, the clamshell core and the first and second end couplers each include tapered sections used to impart the force to create the mechanical deformation via the interference fit.

In one or more of the above examples, one or more set screws are disposed in one or more respective apertures of the clamshell core to provide structural rigidity.

In one or more of the above examples, the end of each of the two piping sections includes knurled sections that provide a mechanical resistance with the clamshell core.

In one or more of the above examples, a body of the clamshell core includes ridges that provide a mechanical resistance with the two piping sections.

In one or more of the above examples, the clamshell core includes teeth that mesh with grooves on an outside portion of the two piping sections.

In one or more of the above examples, the clamshell core includes two separate pieces and the method further comprises fitting the two separate pieces of the clamshell core over the end of each of the two piping sections.

In one or more of the above examples, the two piping sections include indexed teeth that mesh with teeth of the clamshell core, and the method further comprises removing a set of the indexed teeth of the two piping sections during a repair procedure.

In one or more of the above examples, inserting the first end coupler and the second end coupler into respective ends of the center coupler body includes interfacing a threaded portion of each of the first and second end couplers with an interior threaded portion of the center coupler body.

It will be understood by those skilled in the art that various changes may be made to this disclosure, and equivalents may be substituted for elements thereof without departing from the scope of the disclosure. In addition, many modifications may be made to adapt a particular situation or material to the teachings of this disclosure without departing from the essential scope thereof. Therefore, it is intended that this disclosure not be limited to the particular embodiment disclosed as the best mode contemplated for carrying out this disclosure, but that this disclosure will include all embodiments falling within the scope of the appended claims. While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A field repairable flangeless lined piping connection system, comprising:
a clamshell core operable to fit over an end of each of two piping sections and join the two piping sections; and
a coupler assembly including:
a center coupler body having a receiving bore and operable to be disposed over the clamshell core; and
a first end coupler and a second end coupler each disposed over one of the two piping sections, wherein each of the first end coupler and the second end coupler include an exterior mirroring the receiving bore of the center coupler body, and wherein the first end coupler and the second end coupler are operable to be inserted into respective ends of the center coupler body.

2. The field repairable flangeless lined piping connection system of claim 1, wherein insertion of the first and second end couplers into the center coupling body imparts a force to create a mechanical deformation via an interference fit.

3. The field repairable flangeless lined piping connection system of claim 2, wherein the clamshell core and the first and second end couplers each include tapered sections used to impart the force to create the mechanical deformation via the interference fit.

4. The field repairable flangeless lined piping connection system of claim 1, wherein one or more set screws are disposed in one or more respective apertures of the clamshell core to provide structural rigidity.

5. The field repairable flangeless lined piping connection system of claim 1, wherein the end of each of the two piping sections includes knurled sections that provide a mechanical resistance with the clamshell core.

6. The field repairable flangeless lined piping connection system of claim 1, wherein a body of the clamshell core includes ridges that provide a mechanical resistance with the two piping sections.

7. The field repairable flangeless lined piping connection system of claim 1, wherein the clamshell core includes teeth that mesh with grooves on an outside portion of the two piping sections.

8. The field repairable flangeless lined piping connection system of claim 1, wherein the clamshell core includes two separate pieces that are operable to fit over the end of each of the two piping sections.

9. The field repairable flangeless lined piping connection system of claim 1, wherein the two piping sections include indexed teeth that mesh with teeth of the clamshell core, and wherein a set of the indexed teeth of the two piping sections is operable to be removed during a repair procedure.

10. The field repairable flangeless lined piping connection system of claim 1, wherein the first and second end couplers each include a threaded portion that interfaces with an interior threaded portion of the center coupler body during insertion of the first and second end couplers into the respective ends of the center coupler body.

11. A method of installing a field repairable flangeless piping connection system, the method comprising:
arranging two piping sections together, each of the two piping sections having a plastic liner;
fusing the plastic liner of each of the two piping sections together;
fitting a clamshell core over an end of each of two piping sections to join the two piping sections;
disposing a center coupler body having a receiving bore over the clamshell core;
disposing a first end coupler over one of the two piping sections and a second end coupler over the other of the two piping sections, wherein each of the first end coupler and the second end coupler include an exterior mirroring the receiving bore of the center coupler body; and
inserting the first end coupler and the second end coupler into respective ends of the center coupler body.

12. The method of claim 11, wherein inserting the first and second end couplers into the center coupler body imparts a force to create a mechanical deformation via an interference fit.

13. The method of claim 12, wherein the clamshell core and the first and second end couplers each include tapered sections used to impart the force to create the mechanical deformation via the interference fit.

14. The method of claim 11, wherein one or more set screws are disposed in one or more respective apertures of the clamshell core to provide structural rigidity.

15. The method of claim 11, wherein the end of each of the two piping sections includes knurled sections that provide a mechanical resistance with the clamshell core.

16. The method of claim 11, wherein a body of the clamshell core includes ridges that provide a mechanical resistance with the two piping sections.

17. The method of claim 11, wherein the clamshell core includes teeth that mesh with grooves on an outside portion of the two piping sections.

18. The method of claim 11, wherein the clamshell core includes two separate pieces and the method further comprises fitting the two separate pieces of the clamshell core over the end of each of the two piping sections.

19. The method of claim 11, wherein the two piping sections include indexed teeth that mesh with teeth of the clamshell core, and the method further comprises removing a set of the indexed teeth of the two piping sections during a repair procedure.

20. The method of claim 11, wherein inserting the first end coupler and the second end coupler into respective ends of the center coupler body includes interfacing a threaded portion of each of the first and second end couplers with an interior threaded portion of the center coupler body.
